(19) United States
(12) Patent Application Publication
(10) Pub. No.: US 2023/0385034 A1
(43) Pub. Date: Nov. 30, 2023

(54) AUTOMATED DECISION MAKING USING STAGED MACHINE LEARNING

(71) Applicant: TUPL Inc., Bellevue, WA (US)

(72) Inventors: Pablo Tapia, Bellevue, WA (US); Xiang Chen, Bellevue, WA (US); Rafael Guerrero, Atlanta, GA (US)

(21) Appl. No.: 18/448,048

(22) Filed: Aug. 10, 2023

Related U.S. Application Data
(62) Division of application No. 15/919,435, filed on Mar. 13, 2018, now abandoned.
(60) Provisional application No. 62/471,319, filed on Mar. 14, 2017.

(51) Int. Cl. G06F 8/34; G06Q 10/0639; G06F 9/451; G06N 20/00; G06F 15/76; G06N 20/20; G06N 3/08; G06F 18/214; G06F 18/21; G06N 5/01

(52) U.S. Cl. CPC G06F 8/34; G06Q 10/06393; G06F 9/453; G06N 20/00; G06F 15/76; G06N 20/20; G06N 3/08; G06F 18/2148; G06F 18/217; G06N 5/01; G06N 7/01

(57) ABSTRACT

Techniques are described for using artificial intelligence (i.e., machine learning) to identify a system problem. Multiple machine learning stages, or models, are used to better categorize inputs and more quickly derive a reliable solution. Each subsequent model identifies a more specific category than a previous model, i.e., each successive model operates on a more granular level. The described techniques include staged machine learning models and user interface elements that are used to train a system and support an application development process. These techniques can be used to more easily create logic that is directed to solving a problem in a particular system.

### CROSS-REFERENCE TO RELATED APPLICATION

This application is a Divisional of U.S. application Ser. No. 15/919,435, filed Mar. 13, 2018, which claims the benefit of Provisional U.S. Patent Application No. 62/471,319 filed on Mar. 14, 2017.

### BACKGROUND

Since the creation of computerized systems, a need has existed to identify problems with system functionality and to derive solutions to repair undesirable artifacts such as transmission delays, data corruption, etc., or to predict when system failure may occur or when maintenance is needed. Such work has been referred to as “automated solutions,” “quality of service (QoS),” “predictive services,” etc.

A foundational part of automated system solutions are the acts of gathering data and extracting relevant pieces of information in a correlated manner. Performance is measured and data pertaining thereto is analyzed to determine if performance deficiencies exist and, if so, a determination is made as to how the deficiencies may be remedied, or even if performance problems may arise in the future. Such work requires significant human interaction to perform these tasks. Furthermore, many enterprises do not have the ability to support the kind of trained professionals that are able to do such work and they are often left to hire specialized contractors to manage portions of work related to supporting enterprise systems.

Automated solutions exist that monitor and analyze performance of systems and provide information to system technicians that help the technicians identify and resolve problems or proactively identify future issues. Although such solutions conserve human activity and interaction, they are complex and rely on heuristic models to a significant degree. This requires extensive effort to build and fine-tune logic for each automated solution, but each solution is directed to solving problems on a particular system and is typically difficult to adapt to different environments. Furthermore, such systems typically focus only on a specific aspect of an operation and are not operating with a holistic view of a system.

### BRIEF DESCRIPTION OF THE DRAWINGS

The Detailed Description, below, makes reference to the accompanying figures. In the figures, the left-most digit(s) of a reference use of the same reference numbers in different figures indicates similar or identical items.

FIG. 1 depicts a diagram of an example generic multistage machine learning pipeline that is implemented in the techniques described herein.

FIG. 2 is an example computing device constructed in accordance with the present description.

FIG. 3 is an example user interface for providing machine learning training.

FIG. 4 is a diagram of an example technique to define a new category model as described in at least one implementation herein.

FIG. 5 is a diagram of an example technique to add new categories to an existing model as described in at least one implementation herein.

FIG. 6 is an example interface depicting a technique for automatic grouping of input data for use in one or more of the implementations described herein.

FIG. 7 is a diagram of an example multi-stage model tree that may be used in one or more implementations described herein.

FIG. 8 is an example of a user interface that shows model training analysis screen in accordance with one or more implementations described herein.

FIG. 9 is an example of a feature implementation interface that may be used in accordance with one or more implementations described herein.

FIG. 10 is a two-dimensional representation depicting an example of a decision of whether a given sample should belong to a new category as described herein with respect to one or more implementations.

FIG. 11 is an example user interface training window in accordance with the present description.

### SUMMARY

The techniques described herein relate to generalization of creation of applications, based on artificial intelligence (i.e. machine learning), that classify problems in managed stages and identify a problem, and are sometimes able to recommend one or more solutions. Using stages in a classification process requires less human interaction while increasing the likelihood that results will be meaningful. Such techniques can be used to create system solutions applications that are able to find a root cause of a problem and provide one or more possible solutions to the problem. The tools described herein can be used to support an application development process—from machine learning models to user interface widgets used to train a system. Such tools that use staged machine learning can be used to more easily create logic that is directed to a particular problem.

### DETAILED DESCRIPTION

Typical application of machine learning involves receiving a data set, running a machine learning algorithm, recognizing patterns, and reporting issues. Supervised learning posits a structure, i.e., a model, that usually comprises a set of categories and Key Performance Indicators (KPI) specified by a subject matter expert. Examples of supervised algorithms include Naïve Bayes, Logistic Regression, Random Forest, etc. Unsupervised learning lets the machine learning algorithm find its own patterns.

One problem that can arise with supervised learning is that if a structure is used that is too complex (i.e., there are too many categories), data won't converge to a meaningful solution. Patterns will be detected, but confidence in the results will not be statistically significant.

In the techniques described herein, a version of supervised learning is described that uses stages. Rather than doing supervised learning in a single stage, a machine learning algorithm is applied only using a partial structure made up of a number of categories and KPIs specified by an expert. Because the structure is simpler, convergence is more likely. The machine learning algorithm is applied and, based on the resulted, another stage is selected. The latter stage uses a different partial structure. This process is repeated until reliable results are obtained.

With each stage, granularity gets finer. For example, if a system relates to an automobile, an initial stage, or model, may indicate that there is a problem with the automobile. A subsequent stage (more granular) may indicate that there is a problem with a specific sub-system of the automobile, such as with an engine cooling system. Working with increasingly granular models in stages allows a problem to be focused in on as the process progresses.

Some of the features of the described techniques are: (1) that the machine learning algorithm can automatically pick which structure (categories and KPIs) to use moving onto the subsequent stage; (2) that the machine learning algorithm can let a subject matter expert intervene and add new categories and KPIs; (3) The machine learning algorithm can automatically suggest new categories and KPIs (similar to unsupervised learning); and (4) when making a new structure, the new structure can be automatically trained with derived data.

### Staged Approach to Machine Learning Resolution

The process of solving system problems can typically be broken down into categories. As initial questions are answered, new dimensions of the problem become apparent. For example, once it is known that there is a problem due to alarms in a site, a question arises as to whether this sort of a problem requires escalation. For another example, if an initial problem is detected in a certain geographical area (e.g., a cluster), a question arises as to whether the problem is localized or if it is part of a wider problem.

The number and type of information pieces (i.e. “features”) needed to resolve a problem depends on the specific issue that needs to be addressed. In the example, above, regarding determining whether a product is localized or on a larger scale, a new set of Key Performance Indicators (KPIs) is required to resolve the issue, possibly including common core, transport, etc.

As an example, consider a two stage scenario. Input to a first model in the example includes: DL Power Lever, UL Power Level, Channel Quality Index, Channel Utilization, Drop Rate, Block Rate, Alarms in Site, etc. An output from the first model may indicate that there is an interference problem. Subsequently, input to a second model may include: DL Power Level, UL Power Level, Power from Outside Sectors, Power in the Edge, Power in the Core, etc. Output from the first model may indicate that there is a problem of interference due to an overshooter cell. Through the addition of a secondary stage, the problem was able to be recognized at a lower level of granularity.

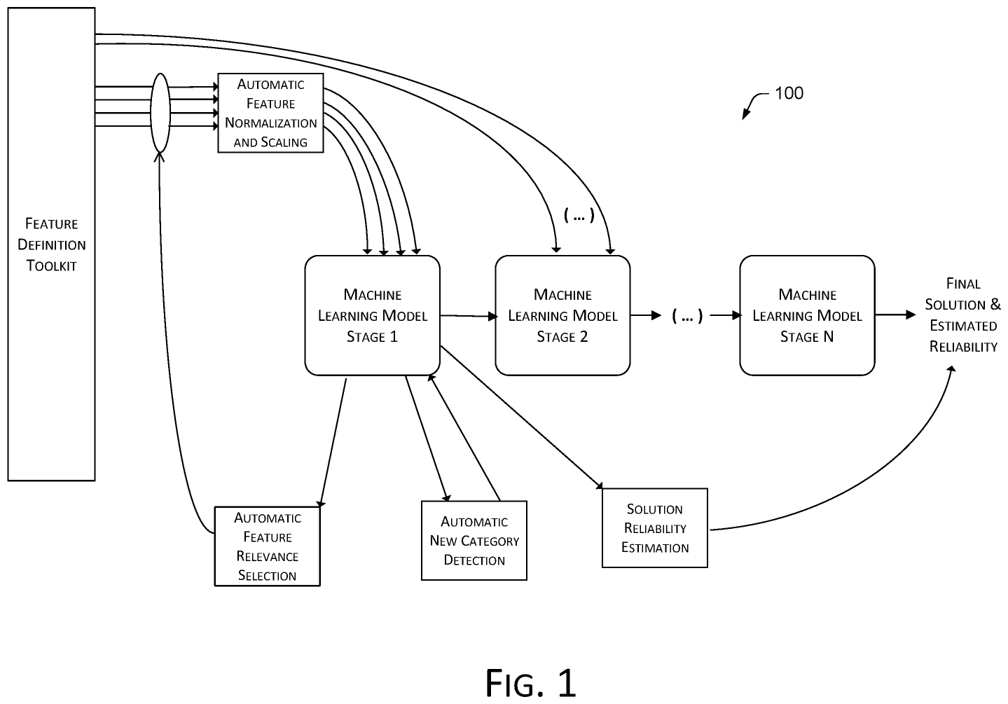

FIG. 1 depicts a diagram 100 of a generic representation of this concept (a generic multistage machine learning pipeline). At each stage in the process, a previous determination is refined into a deeper granularity and, ultimately, into a specific recommendation (e.g., “Escalate Ticket to Network Operations).”

To simplify creation of such logic chains, the following set of generic utilities is described herein, which are described in detail, below. Those generic utilities include:
1. A feature definition component. The feature definition component is a generic utility that permits definition of new features based on a configuration/IDE (Integrated Development Environment) approach.
2. UI Utilities. The user interface utilities enable the creation and training of the model via UI (User Interface) supporting screens.
3. A feature adjustment component that that automatically pre-processes input data based on generic characteristics, e.g. types of data and ranges, number of available training samples for each category, etc.
4. A feature simplification component that attempts to determine what the most relevant feature set is for each model, to try and simplify the convergence and ongoing training.
5. A new category detector. The new category detector is a utility that detects, once the model has been trained, if a new sample would likely belong to a new category that has not yet been covered.
6. A reliability calculator configured to calculates how ready a machine learning stage is to provide accurate recommendations, and estimates the reliability of a given answer.

### Example Operating Environment

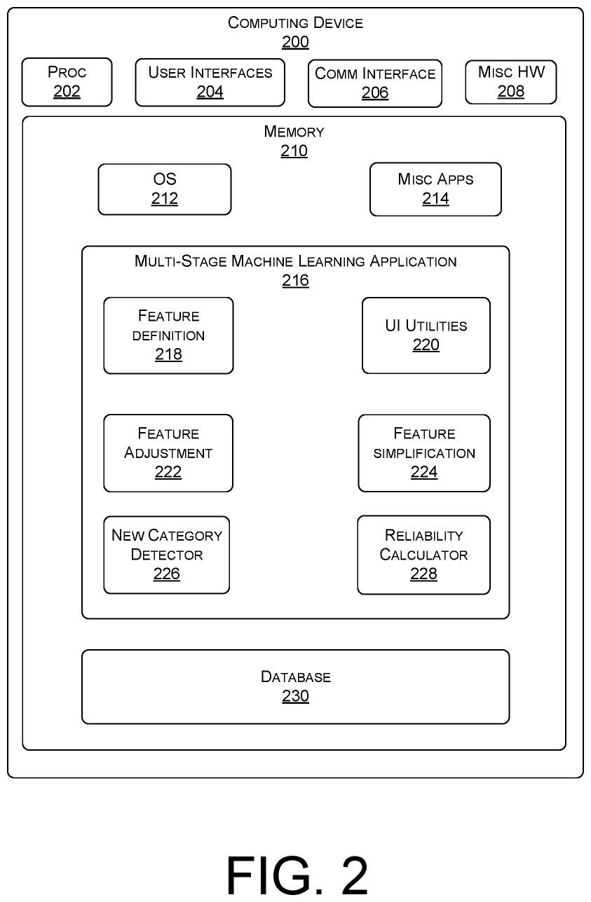

FIG. 2 is a block diagram of an example computing device 200 in which the presently described techniques may be implemented. In the following discussion, certain interactions may be attributed to particular components. It is noted that in at least one alternative implementation not particularly described herein, other component interactions and communications may be provided. The following discussion of FIG. 2 merely represents a subset of all possible implementations. Furthermore, although other implementations may differ, one or more elements of the example computing device 200 are described as a software application that includes, and has components that include, code segments of processor-executable instructions. As such, certain properties attributed to a particular component in the present description, may be performed by one or more other components in an alternate implementation. An alternate attribution of properties, or functions, within the example computing device 200 is not intended to limit the scope of the techniques described herein or the claims appended hereto. Furthermore, the elements shown in the computing device 200 may be implemented in a distributed fashion over multiple computing devices or may be contained—as shown here—in a single computing device.

The example computing device 200 includes one or more processors 202 that process computer-executable instructions. Each of the one or more processors 202 may be a single-core processor or a multi-core processor. The example computing device 200 also includes user interfaces 204 and one or more communication interfaces 206. The user interfaces 204 provide hardware components that provide an interface between a user and the example computing device 200. The user interfaces 204 can include a display monitor, knobs, dials, readouts, printers, keyboards, styluses, etc.

The communication interfaces 206 facilitate communication with components located outside the example computing device 200, and provides networking capabilities for the example computing device 200. For example, the computing device 200, by way of the communications interface 206, may exchange data with other electronic devices (e.g., laptops, computers, etc.) via one or more networks, such as a private network, the Internet, etc. Communications between the example computing device 200 and other electronic devices may utilize any sort of communication protocol known in the art for sending and receiving data and/or voice communications.

The example computing device 200 also includes miscellaneous hardware 208. The miscellaneous hardware 208 includes hardware components and associated software and/or or firmware used to carry out device operations. Included in the miscellaneous hardware 208 are one or more user interface hardware components not shown individually—such as a keyboard, a mouse, a display, a microphone, a camera, and/or the like—that support user interaction with the example computing device 200.

The example computing device 200 also includes memory 210 that stores data, executable instructions, modules, components, data structures, etc. The memory 210 can be implemented using computer-readable media. Computer-readable media includes at least two types of computer-readable media, namely computer storage media and communications media. Computer storage media includes volatile and non-volatile, removable and non-removable media for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices. Computer storage media may also be referred to as “non-transitory” media. The term “non-transitory” is used to contrast computer storage media from communication media, and refers to a tangible component that can store computer-executable programs, applications, instructions, etc. In contrast, communication media may embody a modulated data signal, such as a carrier wave, or other transmission mechanism.

An operating system 212 is stored in the memory 210 of the example computing system 200. The operating system 212 controls functionality of the processor 202, the communications interfaces 204, the communication interfaces 206, the miscellaneous hardware 208, and memory operations. Furthermore, the operating system 212 includes components that enable the example computing device 200 to receive and transmit data via various inputs (e.g., user controls, network interfaces, and/or memory devices), as well as process data using the processor 202 to generate output. The operating system 212 can include a presentation component that controls presentation of output (e.g., display the data on an electronic display, store the data in memory, transmit the data to another electronic device, etc.). Additionally, the operating system 212 can include other components that perform various additional functions generally associated with a typical operating system. The memory 210 also stores miscellaneous software applications 214, or programs, that provide or support functionality for the example computing device 200, or provide a general or specialized device user function that may or may not be related to the example computing device 200 per se. The software applications 214 can include system software applications and executable applications that carry out non-system functions.

A multi-stage machine learning application 216 is stored in the memory and drives the multi-stage machine learning operations described herein. The multi-stage machine learning application 216 includes a feature definition component 218, user interface (UI) utilities 220, and an automatic feature adjustment component 222. The multi-stage machine learning application 216 also includes a feature simplification component 224, a new category detector 226, and a reliability calculator 228. A database 230 is also stored in the memory 210 and is configured to store data from and provide data to the multi-stage machine learning application 216 and other components of the computing device 200.

The components and features of the multi-stage learning application 216 will be described in greater detail below, with respect to one or more subsequent figures. In the following discussion, continuing reference is made to the elements and referenced numerals shown in FIG. 2.

### Feature Definition Component

To simplify the complexity of the machine learning algorithms, relatively complex features are created, which are derived from specific domain knowledge from network technicians. Instead of simply feeding data inputs like KPIs, parameters, etc., the techniques described herein contemplate digesting this information into typical information bits that technicians typically use in a decision-making process. Examples of such features include, but are not limited to: (a) whether or not a node on a network is congested; (b) whether or not a system terminal supports LTE 700 band; (c) whether a membrane in a water desalinization system is operating at low efficiency; and (d) whether or not there was a critical alarm active in a system element for a previous period of time.

Implementations of the techniques described herein support the following generic utilities: (a) Definition of special metrics based on text variables, e.g., the operating system name contains “Android,” a description includes the phrase “at home,” etc.; (b) Calculation of KPIs at various aggregation level, for various metrics such as counters, alarms, user Call Detail Records (CDRs), etc.; (c) Calculation of alerts for any given KPI; (d) Calculation of anomalies for any given KPI, comparing a specific hour/day to previous x weeks for the same hour/day period; and (e) Any combination of results from any of the previously defined functions.

### UI Utilities

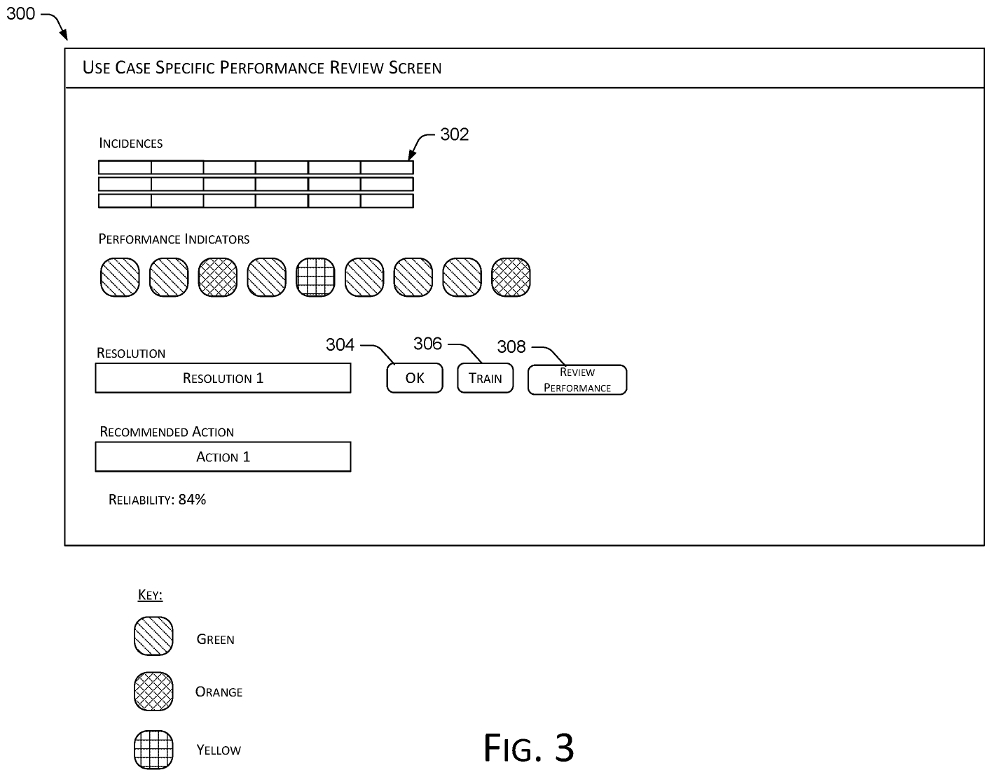

FIG. 3 depicts an example user interface 300 for providing machine learning training that may be used in one or more of the implementations described herein. Creation of new tools, processes, or algorithms based on machine learning stages are facilitated via a series of UI utilities in which a user has the ability to create the different stages and/or categories that will be necessary to the task, select the relevant feature set for each stage, and monitor the performance of each of the machine learning stages.

The example user interface 300 displays a set of incidences 302, e.g., detected system issues, customer complaints, etc., together with a high-level summary of relevant metrics or features that help a user decide what a potential resolution should be. A feature can include complex representations of a combination of data feeds. The example user interface 300 also includes an “OK” button 304, a “Train” button 306, and a “Review Performance” button 308.

When the “OK” button 304 is actuated, a currently displayed resolution is accepted. When the “Train” button 306 is actuated, a new training sample is created. When the “Review Performance” button 308 is actuated, an overall performance of the machine learning system is presented for review.

### Creation Wizard

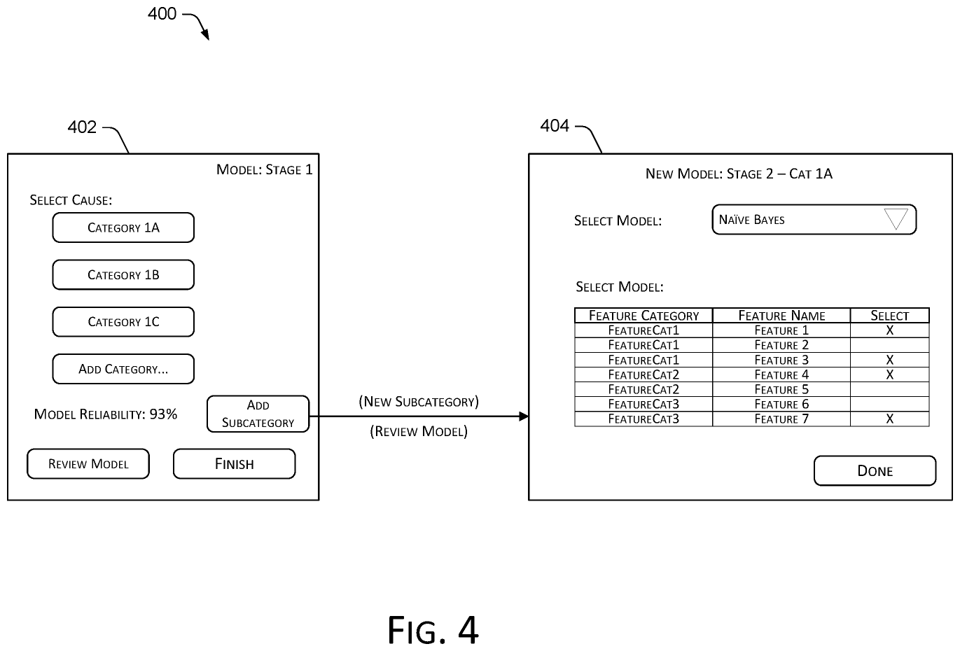

FIG. 4 depicts a diagram 400 of an example technique to define a new category model as described in at least one implementation herein. In one or more implementations described herein, when a user decides to use a current incidence to train a model, a set of screen utilities 402, 404 are displayed. These utilities are meant to record decisions made by a user technician. If an existing resolution does not exist (i.e., one has not been presented to the user), the user can select a specific machine learning model to be used in this stage, as well as an initial set of features to input into the model.

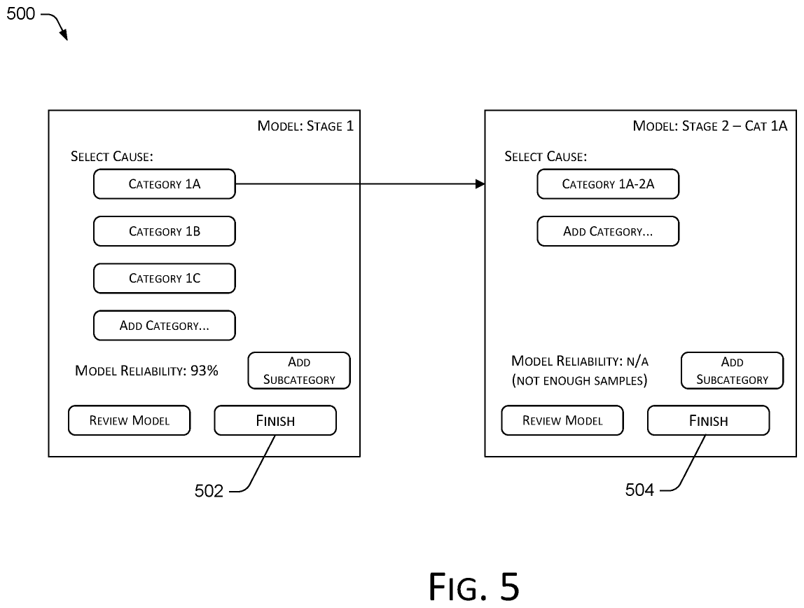

Once a category has been created, the user has the ability to add new categories within the model using a user interface element 500 similar to that shown and described with respect to FIG. 5. When the process has been completed, the user will have made a selection of categories and subcategories for a current sample. When a “Finish” button 502, 504 is selected, a new training sample is recorded for relevant models (Stage 1, Stage 2, etc.).

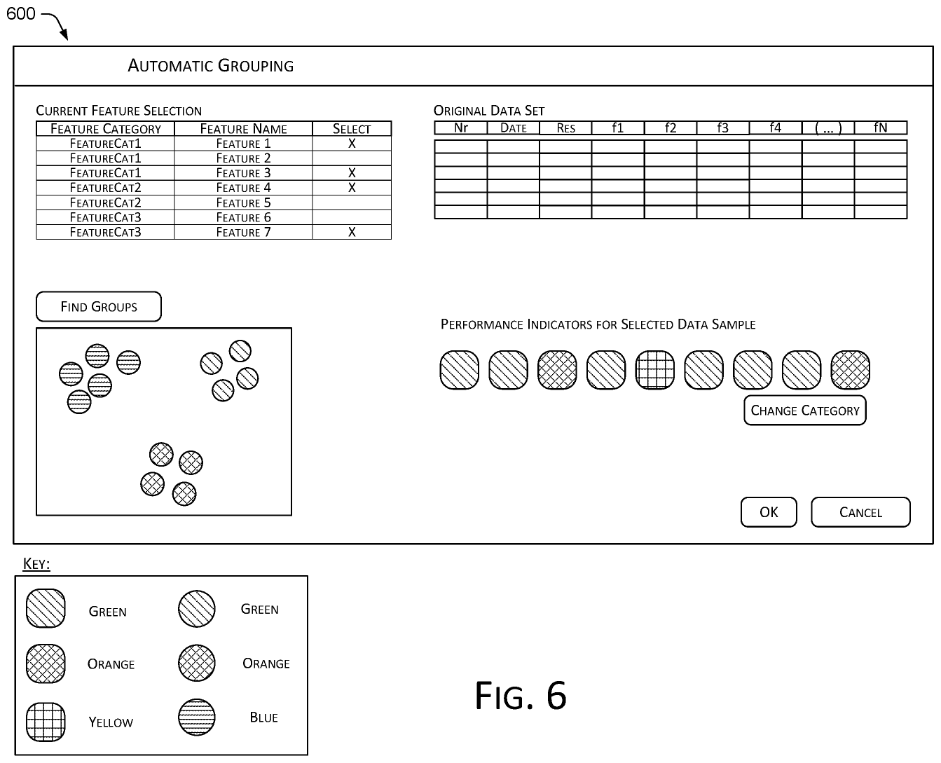

FIG. 6 is an example user interface 600 depicting a technique for automatic grouping of input data for use in one or more of the implementations described herein. The UI 600 includes utilities to suggest creation of new data categories for a newly created stage. This provides an alternative to training the data samples one by one.

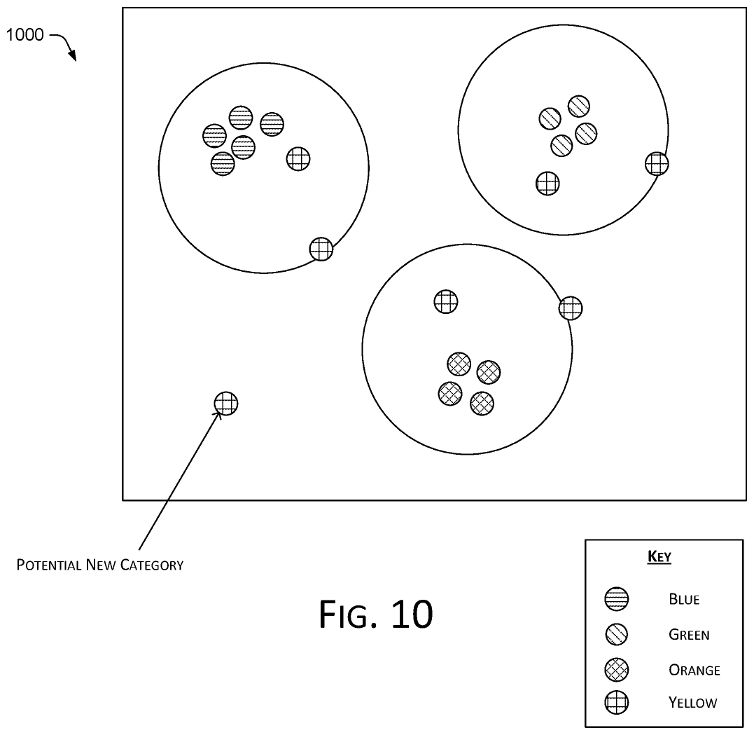

To derive at least a part of the example user interface 600 shown in FIG. 6, an initial classification method is applied to an original data set. When the data groups have been created, the user may decide to change the category of certain data samples. This process is described in greater detail, below, with respect to FIG. 10.

Once the machine learning model has been trained and is in operation, the system will detect when a given new data sample does not seem to fit within one of the existing categories. This is indicated to the user when a resolution field shows “unknown resolution—potential new category.” The user is then able to create a new category and add the sample to the training set.

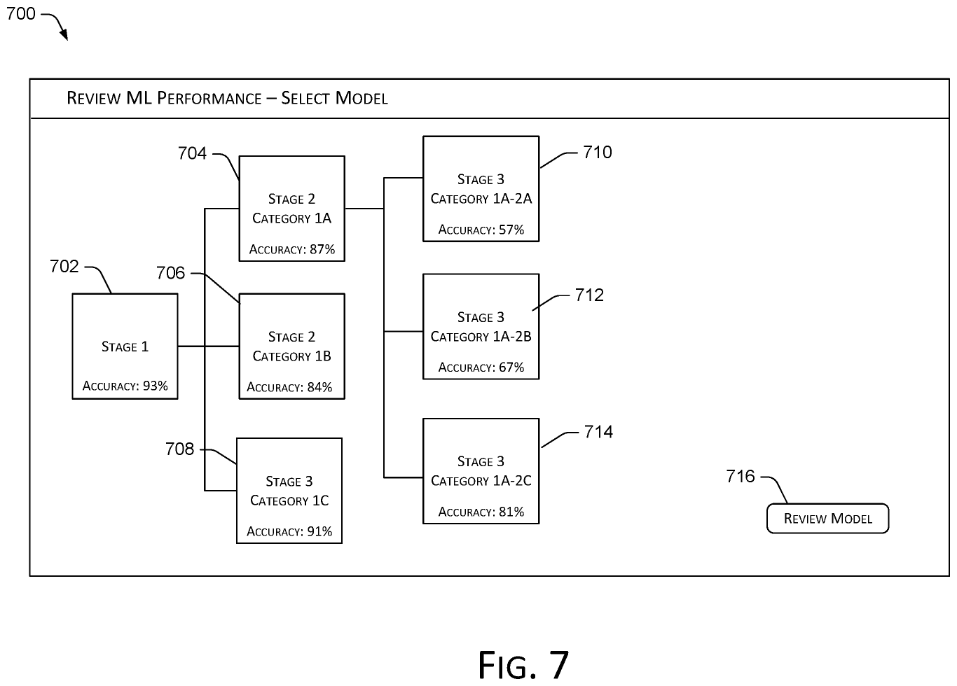

FIG. 7 is a diagram of an example multi-stage model tree 700 that may be used in one or more implementations described herein. The model tree 700 shows all models 702-714 that have been created with the tool to date. Each model 702-714 indicates the accuracy for the model. Each model 702-714 is selectable. When a user wishes to review a model, the user selects one of the models 702-714 and actuates a “Review Model” button 716.

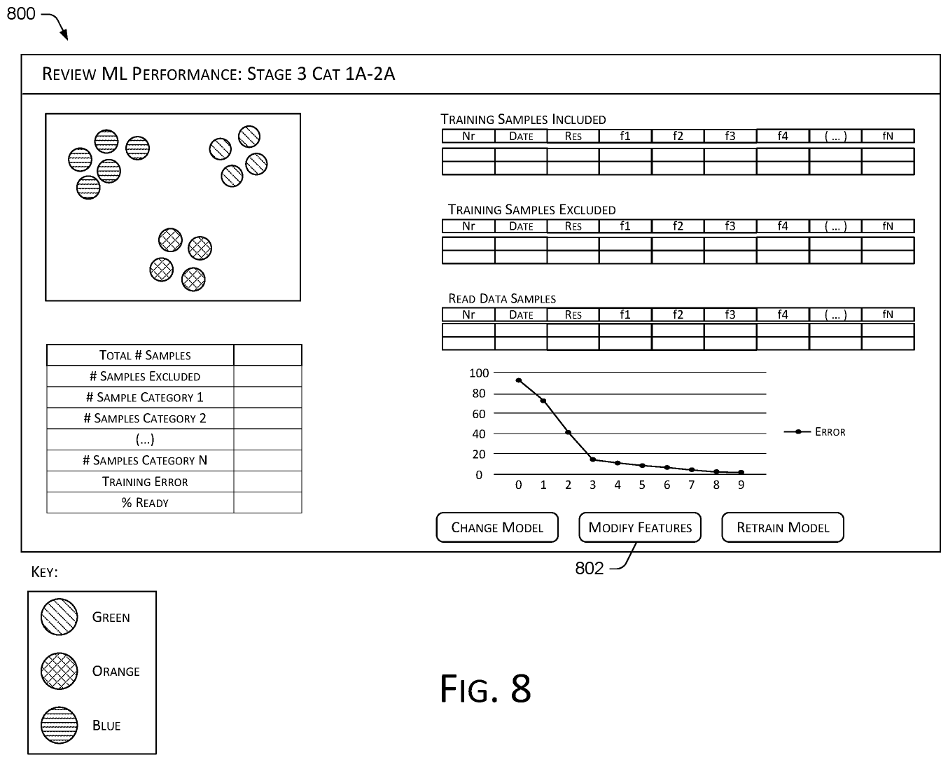

FIG. 8 is an example user interface 800 that shows model training analysis screen 800 in accordance with one or more implementations described herein. The model training analysis screen 800 is shown upon selection of the “Review Model” button 716 shown and described with respect to FIG. 7.

On the model training analysis screen 800, a user can see an overall performance of a specific model: the training samples used, the training error, and the overall accuracy. It also has utilities to select a different model, to modify the current feature set (add/remove), or to retrain the model. It is noted that models and training data can be stored for each unique user. Furthermore, a master model may be utilized that is common to multiple users, and user-specific training data may be applied to the master model.

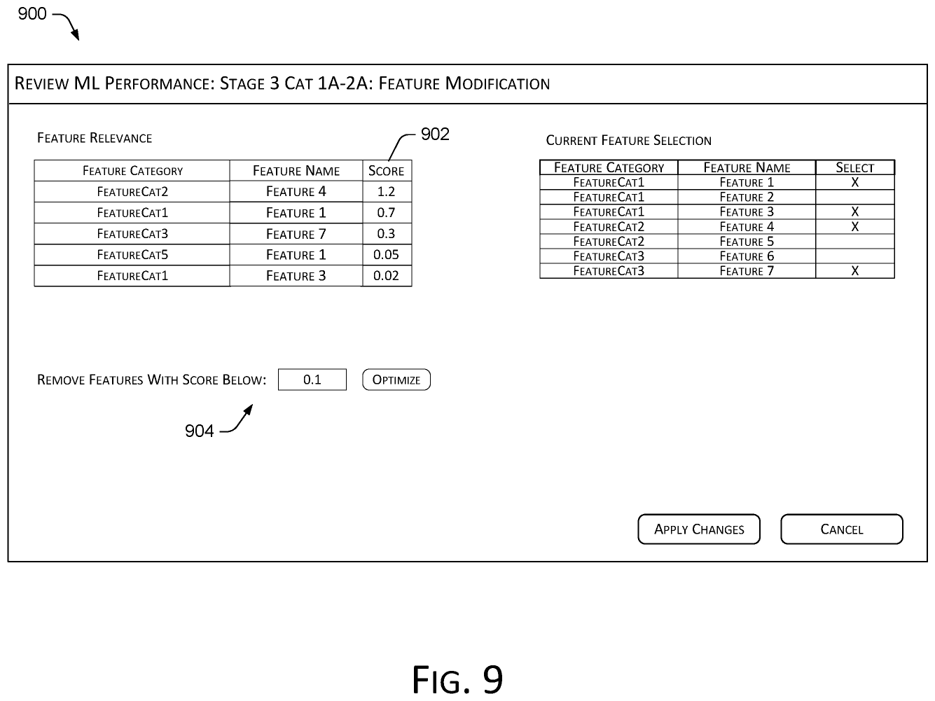

The model training analysis screen 800 indicates the training samples as well as new data samples. The model training analysis screen 800 is further configured to invoke functions that are described in detail below. A “Modify Features” button 802 is also included that, when selected, presents the display shown and described with respect to FIG. 9.

FIG. 9 is an example of a feature implementation interface 900 that may be used in accordance with one or more implementations described herein. The feature implementation interface 900 is displayed when the “Modify Features” button 802 (FIG. 8) is actuated. In the example shown, the current set of features is presented to the user by order of relevance, which may be determined in various ways. Here, the relevance is determined by a score 902. The user can then decide what features can be eliminated for each stage.

The feature implementation interface 900 also provides a utility 904 to remove all features having a score lower than a certain threshold.

### Automatic Feature Adjustment

The automatic feature adjustment module 220 (FIG. 2) is configured to automatically adjust input features to ensure that the machine learning algorithm functions properly and is not skewed towards a particular resolution. The feature adjustment module is configured to prepare a scaling function and to apply the scaling to any future samples that are fed into the tool/process/algorithm.

Preparation of a scaling function. Based on the training set, the feature adjustment module analyzes types of data and value ranges for each individual feature. Then a mean and standard deviation are derived for each of them.

Application of the scaling function. For each data sample (both training and new data sets), a normalized data set is calculated. The normalized data set is user defined. For example, a user may set the normalized data set to be equal to x-mean/std.

Balancing of Categories. In cases where the training data presents a serious imbalance between categories (e.g., there are 10 times more samples for category 1 than for category 2), the system may produce inaccurate results, typically favoring the category that has more data samples. A “Balancing of Categories” function is configured to calculate a number of training samples in each category, and if a serious imbalance is found, it will oversample the less frequent categories, copying random samples from the less frequent categories. The deviation that must be present to be considered a “serious” imbalance is configurable.

### Automatic Feature Simplification

The automatic feature simplification module 224 (FIG. 2) is configured to evaluate, at every stage model, the most relevant features used during the classification. It is further configured to rank the features and present the results to the user via a corresponding user interface.

The automatic feature simplification module 224 is also configured to provide a user option to automatically simplify the feature set based on relative scores. If a number of features is higher than a specified threshold, features with an absolute weight less than a configured threshold (e.g., 10%) of an average of absolute weight of the top x features (e.g., 3, etc.) may be eliminated.

### Reliability (Performance Metrics) Calculator

The reliability calculator 228 (FIG. 2) is configured to provide a series of metrics that are useful to understand the performance and reliability of a given machine learning model. Given a machine learning model and a training set, the reliability module is configured to determine if there is a sufficient number of training samples to provide a proper estimation. This indication is provided for the entire model, as well as for each category. Having this information provides a sense of whether a specific category needs additional training data for the model to be considered reliable. This information is calculated based on a number of features and a number of classes in the model. The more features that are included, and the greater the number of classes in the model, the more samples are required to properly train the model.

A model accuracy is calculated as the sum of true positives plus true negatives divided by a total number of validation samples. A model recall feature is included that is configured to provide statistics (“Recall”) of True Positives divided by the sum of True Positives plus False Negatives for the validation data set. A model precision feature provides statistics (“Precision”) of True Positives divided by all positive guesses (true plus false positives) for the validation set.

An F-Score is a harmonic mean between Recall and Precision. It can be used as a way to have a single value that represents the performance of the model. A known form of an F-Score is (2*Precision*Recall/(Precision+Recall)). However, this formula is configurable to give more weight to Precision or Recall as desired.

A sample reliability estimation function indicates a probability of error for an estimated result of a given input data vector. A Receiver Operating Curve (ROC) summarizes classifier performance over a range of trade-offs between True Positive and False Positive error rates. The x-axis represents a percentage of False Positives (FPR=FP/TN+FP) and the y-axis represents percentage of True Positives (TPR=TP/TP+FN).

A Projection utility to project data samples in 2-D may also be included. Such a utility provides a 2-D representation of a given set of data vectors. This is useful to display the data in the screen for analysis purposes, and is sometimes referred to as “dimensionality reduction.” This representation may be implemented based on one of various methods, including a t-SNE (t-distributed Stochastic Neighbor Embedding) method, a Sammon projection, or the like.

### Automatic Detection of New Categories

In at least one implementation, an alternative method to produce training samples during the initial stage is used (“New Category Detector” 224, FIG. 2), wherein an unsupervised classification mechanism is applied to the original unlabeled data set. Doing this can unveil natural grouping patterns based on feature sets. This function may use a clustering mechanism such as K-Means, DBScan, or another function. In cases like K-Means, where a number of clusters is not known ahead of time, there is a method to select the optimum number of clusters by analyzing the overall error vs. cluster size.

Once data groups have been created, a user can decide to reclassify certain data samples. This effectively produces a new training set that can be used to train a supervised classification model. Once a stage model has been trained, new samples are classified based on the trained model. For every given sample, the model attempts to decide a corresponding category. If the reliability of the result is low (e.g. <60% or some other pre-defined threshold), a determination is made as to whether the sample belongs in a new category.

FIG. 10 is a two-dimensional representation 1000 depicting an example of a decision of whether a given sample should belong to a new category as described herein with respect to one or more implementations. This may be accomplished in various ways. One option is to use an N-dimension Euclidean distance between samples, using the output classification probability vector as sample coordinates. The center and radius (typical distance) could then be calculated for the training set. If the new sample is far away from the existing groups (a figure that is configurable), then it may suggest a potential new candidate.

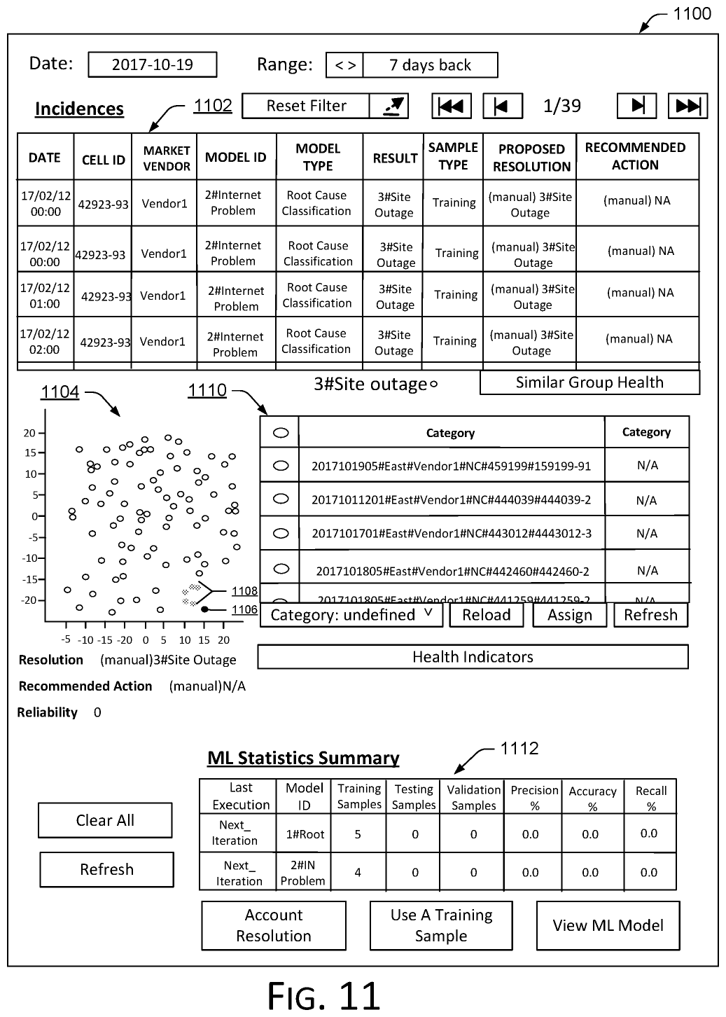

FIG. 11 is an example user interface training window 1100 that displays information relate to incidences. The training window 1100 includes various user interface sections that may be implemented as shown, or in similar implementations that may use more or fewer user interface elements. The training window 1100 includes an incidence table 1102 that shows a number of incidences in rows with health indicators for each incidence. The training window 1100 also includes a correlation map 1104 that maps all samples. A selected sample 1106 that has been selected by a user is shown in the correlation map 1104 together with samples 1108 that are similar to the selected sample 1106.

The example user interface training window 1100 also includes a similar incidence table 1110 that shows information related to samples 1108 that are similar to the selected sample 1106. Additionally, a machine learning summary table 1112 is includes in the training window 1100 and shows various statistics related to the incidences. Although certain statistics are shown in the machine learning summary table 1112, additional, fewer, and/or different statistics may be displayed.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method for configuring a multistage machine learning (ML) pipeline, comprising:
providing a model creation user interface (UI) configured to receive a selection of a model type for creating a new ML model, receive one or more selections of input features for the new ML model from a list of one or more features, and receive an indication that selection of parameters for the new ML model is finished;
in response to receiving the indication that selection of parameters for the new ML model is finished through the model creation UI, creating the new ML model using the model type and input features selected through the model creation UI and inserting the new ML model in a multistage model tree;
providing a model tree UI configured to display the multistage model tree and receive a selection of a first ML model from among the ML models;
in response to receiving the selection of the first ML model through the model tree UI, providing a model performance UI configured to display an overall performance of the first ML model and a first list of actions and to receive a selection of a first selected action from the first list of actions;
in response to receiving the selection of first selected action through the model performance UI, performing the first selected action on the first ML model,
wherein the multistage model tree comprises:
a first machine learning stage including a first-stage ML model configured to receiving a first data set including performance indicators related to a system and to categorize data in the first data set to produce a first category,
a second machine learning stage including a second-stage ML model configured to receive a second data set that is related to the first category and categorize the second data set to produce a second category.

2. The method as recited in claim 1, wherein the second category is more specific than the first category.

3. The method of claim 1, wherein the multistage model tree further comprises a third machine learning stage including a third-stage ML model configured to receive a third data set that is related to the second category and to categorize the third data set to produce a third category.

4. The method as recited in claim 3, wherein the third category is more specific than the second category.

5. The method of claim 1, further comprising:
storing the first machine learning stage and first training data associated with the first machine learning stage in a database and associating the first machine learning stage and first training data with a first user that created the first machine learning stage;
storing the second machine learning stage and second training data associated with the second machine learning stage in the database and associating the second machine learning stage and second training data with a second user that created the second machine learning stage.

6. The method as recited in claim 1, wherein the first data set further comprises key performance indicators (KPI).

7. The method as recited in claim 1, wherein the first data set further comprises features that are derived from features derived from specific domain information related to the system.

8. The method of claim 1, wherein the first list of actions comprises a change model action, a modify features action, and a retrain model action.

9. The method of claim 1, further comprising providing a model training UI configured to:
display a set of incidences, a summary of one or more metrics, one or more features, or both, and a second list of actions;
receive a selection of a second selected action from the second list of actions; and
when the second selected action indicates a training action, create a new training sample.

10. The method of claim 1, further comprising providing a feature implementation UI configured to:
display a set of feature relevance indications, each feature relevance indication including a name of a corresponding feature and a score of the corresponding feature;
display a set of feature selection indications, each feature selection indication including a name of a corresponding feature and a selection indication of the corresponding feature; and
receive an indication of one or more features to select, remove, or both, or an indication of a criteria for removing features, or both.

11. The method of claim 1, wherein the model performance UI is further configured to display one or more model training statistics including a number of training samples, a number of training samples excluded, a training error, a number of training samples of a category, a ready percentage, or a combination thereof.

12. One or more non-transitory computer-readable media (CRM) containing computer-executable instructions that, when executed on a computer, cause the computer to perform operations for configuring a multistage machine-learning (ML) pipeline, the operations comprising:
providing a model creation user interface (UI) configured to receive a selection of a model type for creating a new ML model, receive one or more selections of input features for the new ML model from a list of one or more features, and receive an indication that selection of parameters for the new ML model is finished;
in response to receiving the indication that selection of parameters for the new ML model is finished through the model creation UI, creating the new ML model using the model type and input features selected through the model creation UI and inserting the new ML model in a multistage model tree;
providing a model tree UI configured to display the multistage model tree and receive a selection of a first ML model from among the ML models;
in response to receiving the selection of the first ML model through the model tree UI, providing a model performance UI configured to display an overall performance of the first ML model and a first list of actions and to receive a selection of a first selected action from the first list of actions;
in response to receiving the selection of the first selected action through the model performance UI, performing the first selected action on the first ML model,
wherein the multistage model tree comprises:
a first machine learning stage including a first-stage ML model configured to receive an input data set related to one or more system health indicators and output a first category;
a second machine learning stage including a second-stage ML model configured to receive input data related to the first category and output a second category.

13. The one or more CRM of claim 12, wherein the operations further comprise determining a reliability score for the new ML model and wherein the model creation user interface (UI) is further configured to display the reliability score.

14. The one or more CRM of claim 12, wherein when insert the new ML model in the multistage model tree comprises inserting the new ML model in the second machine learning stage, the operations further comprise creating a new subcategory for the first machine learning stage.

15. The one or more CRM of claim 12, wherein when insert the new ML model in the multistage model tree comprises inserting the new ML model in the second machine learning stage, the operations further comprise creating a new category for the second machine learning stage.

16. The one or more CRM of claim 12, wherein the input data set comprises a set of features that includes key performance metrics (KPI) and features related to domain information that is specific to a network.

17. The one or more CRM of claim 12, wherein the first list of actions comprises a change model action, a modify features action, and a retrain model action.

18. The one or more CRM of claim 12, wherein the operations further comprise providing a model training UI configured to:
display a set of incidences, a summary of one or more metrics, one or more features, or both, and a second list of actions;
receive a selection of a second selected action from the second list of actions; and
when the second selected action indicates a training action, create a new training sample.

19. The one or more CRM of claim 12, wherein the operations further comprise providing a feature implementation UI configured to:
display a set of feature relevance indications, each feature relevance indication including a name of a corresponding feature and a score of the corresponding feature;
display a set of feature selection indications, each feature selection indication including a name of a corresponding feature and a selection indication of the corresponding feature; and
receive an indication of one or more features to select, remove, or both, or an indication of a criteria for removing features, or both.

20. The one or more CRM of claim 12, wherein the model performance UI is further configured to display one or more model training statistics including a number of training samples, a number of training samples excluded, a training error, a number of training samples of a category, a ready percentage, or a combination thereof.
